(19) United States
(12) Patent Application Publication
(10) Pub. No.: US 2013/0208807 A1
(43) Pub. Date: Aug. 15, 2013

(54) METHOD FOR CODING AND METHOD FOR RECONSTRUCTION OF A BLOCK OF AN IMAGE SEQUENCE AND CORRESPONDING DEVICES

(71) Applicants: Dominique Thoreau, Cesson Sevigne Cedex (FR); Jerome Vieron, Paris (FR); Edouard Francois, Bourg des Comptes (FR); Fabien Racape, Rennes (FR)

(72) Inventors: Dominique Thoreau, Cesson Sevigne Cedex (FR); Jerome Vieron, Paris (FR); Edouard Francois, Bourg des Comptes (FR); Fabien Racape, Rennes (FR)

(73) Assignee: Thomson Licensing, Issy de Moulineaux (FR)

(21) Appl. No.: 13/704,599

(22) PCT Filed: Jun. 7, 2011
(86) PCT No.: PCT/EP2011/059353

§ 371 Date: Mar. 4, 2013

(30) Foreign Application Priority Data
Jun. 15, 2010 (FR) 1054736

(51) Int. Cl. H04N 7/26

(52) U.S. Cl. CPC H04N 19/00387
USPC 375/240.25

(57) ABSTRACT

A method for decoding a video picture comprising coded structured regions and textured regions is disclosed. A reference texture patch is constituted of a part or of blocks of the structured region found around the textured region and the pixels of the textured region are synthesized sequentially according to a spiral type scanning around the textured region, the causal area being found inside the reference texture patch at least for the first round of synthesis.

### SCOPE OF THE INVENTION

The present invention relates to the domain of coding and decoding of a video picture. More specifically it relates to the coding and decoding of textured regions of pictures.

### PRIOR ART

Different schemas exist in the literature relating to the coding of textured regions.

A first method is described in the document by C. Zhu, X. Sun, F. Wu, and H. Li, entitled “Video coding with spatio-temporal texture synthesis”, IEEE International Conference on Multimedia and Expo, 2007, pages 112-115, a method in which some textured regions are removed at the encoder and synthesized at the decoder. The schema is integrated in the codec H.264/AVC, with account taken of bi-directional pictures of type B only. The segmentation based on the calculation of gradient first separates the 8×8 blocks into structure blocks that comprise the borders and the objects, these are encoded in the standard way by H.264, and into texture blocks that are “skipped” and reconstructed via texture synthesis at the decoder.

The method for synthesis used is described in the document by V. Kwatra, A. A. Schdl, I. Essa, G. Turk, and A. Bobick, entitled “Graphcut textures: image and video texture synthesis using graph cuts>>,” Proceedings of ACM SIGGRAPH, 2003, pages 277-286. It is based on “patches”, that is to say it re-copies whole “patterns” of texture then arranges them in order to avoid borders and periodicities.

A second method is described in the document by P. Ndjiki-Nya, T. Hinz, and T. Wiegand, entitled “Generic and robust video coding with texture analysis and synthesis”, IEEE International Conference on Multimedia and Expo, 2007, pages 1447-1450. An approach similar to the preceding approach is proposed, with the idea to remove the blocks for which it is estimated that the texture synthesizer at the decoder is capable of reconstructing.

There are several differences, for example the use of two synthesizers:
the first is for rigid textures, with global motion. This synthesis is heavily linked with global motion compensation algorithms, but differs in the fact that several homogenous regions are considered.
the other is for non-rigid, deformable textures, having local and global motions. The synthesis uses the synthesis algorithm developed in the document “Graphcut textures: image and video texture synthesis using graph cuts” and also used in the document entitled “Video coding with spatio-temporal texture synthesis”.

A third method is described in the document by B. T Oh, Y. Su, A. Segall, J. Kuo, et al. entitled “Synthesis-based texture coding for video compression with side information”, 15th IEEE International Conference on Image Processing, 2008, ICIP 2008, pages 162-163. It proposes an approach based on the texture synthesis developed in the document by V. Kwatra, I. Essa Aaron, and B. N. Kwatra, entitled “Texture Optimization for Example-based Synthesis”, Proceedings of ACM SIGGRAPH, pages 795-802, 2005, that process each pixel separately. However, no mention of parameters of the algorithm is made in the document, such as the size of comparison windows, the number of levels of the pyramid, number of iterations, etc.

The majority of methods presented in the prior art contain patch based synthesizers. The literature provides numerous pixel based alternatives, construction of the texture pixel by pixel, with better visual results on most texture types. The third method of the prior art uses such a synthesizer. However no mention is made of the different parameters used by the pixel based algorithms and of their adjustment and such synthesizers discussed in the prior art are not optimized.

### SUMMARY OF THE INVENTION

One of the purposes of the invention is to overcome the aforementioned disadvantages. The purpose of the invention is a method for decoding a video picture coded according to regions, called structured or textured according to their content, a structured region being coded with a given quality or resolution, a textured region or region part being non-coded or coded with a lower quality, the decoding or a decoding complement of the of the texture region being obtained by a texture synthesis comprising a step of synthesis of pixels from correlations of a neighbouring causal area of the pixel or group of pixels to be synthesized with similar areas in a reference texture patch, determining in a texture patch, a correlated area and the pixel or group of pixels that is positioned, relative to this correlated area, in accordance with the pixel or group of pixels to be synthesized relative to its causal area, characterized in that the reference texture patch is constituted of a part or of blocks of the structured region located around the textured region and in that the pixels of the region of texture are synthesized sequentially according to a spiral type scanning around the textured region, the causal area being found inside the reference texture patch at least for the first round of synthesis.

According to a particular embodiment, the determination of the correlated area is carried out for several predefined sizes of the causal area.

According to a particular embodiment, the causal area is the visible part of a square shaped grid comprising the pixel or group of pixels to be synthesized, on which is applied an adaptive mask adapted to the spiral type scanning position, the mask hiding the pixels of the grid not yet reconstructed.

According to a particular embodiment, the determination of the correlated area is carried out with a resolution at the level of the pixel or of a group of pixels and the synthesis is made at the level of the pixel or at the level of the group of pixels, according to the best correlation obtained.

According to a particular embodiment, at least one part of the textured region being coded at a lower quality, the coding information relative to this region part is taken into account in using, for the determination of the correlated area, in addition to the causal area, an area of the textured region neighbouring the pixel or group of pixels to be synthesized.

According to a particular embodiment, an anchoring point is created in the textured region while coding the block of the textured region with a quality or resolution of that of a block of the structured region and the coding information relative to this block is used for the determination of the correlated area.

The present invention also relates to a method for coding a video source picture comprising a step of segmentation of the picture into regions, a region being declared structured or textured according to its content, a structured region being coded with a given quality or resolution, a textured region or region part being non-coded or coded with a lower quality, characterized in that it carries out a step of synthesis of the textured region or region part to determine the decoding parameters, this step comprising a synthesis of pixels from correlations of a causal area neighbouring the pixel or group of pixels to be synthesized with corresponding areas in a reference texture patch that corresponds to the structured region or region part of the video source picture, while determining in a texture patch a correlated area and the pixel or group of pixels that is positioned, relative to this correlated area, in accordance with the pixel or group of pixels to be synthesized relative to its causal area, the reference texture patch being constituted of an area or of blocks of the structured region located around the textured region and the pixels of the texture region being synthesized sequentially according to a spiral type scanning around the textured region, the causal area being found inside the structured area at least for the first round of synthesis, the choice of parameters being determined by a comparison between the synthesized textured region and the textured region of the video source picture.

According to a particular embodiment, the decoding parameters are of the size and dimensions of the causal area to be taken into account fro the correlation, during the decoding.

The main advantage of the invention is to improve the compression of data while adapting the characteristics of the synthesizer to the sizes and shapes of the patterns of the texture to be processed. The textured regions are removed or degraded in order to preserve bitrate, they are synthesized or refined at the decoder by a “pixel based” synthesizer. The method enables the characteristics of the synthesizer to be adapted to the sizes and shapes of the patterns of the texture to be processed

### BRIEF DESCRIPTION OF THE DRAWINGS

Other characteristics and advantages of the invention will emerge in the following description provided as a non-restrictive example, and referring to the annexed drawings wherein:

FIG. 1, a global schema of coding and decoding,

FIG. 2, an artefact example of the choice of reference patch,

FIG. 3, an example of the synthesized area according to a TV type scanning and a spiral type scanning,

FIG. 4, a spiral type scanning.

### DETAILED DESCRIPTION OF THE EMBODIMENTS OF THE INVENTION

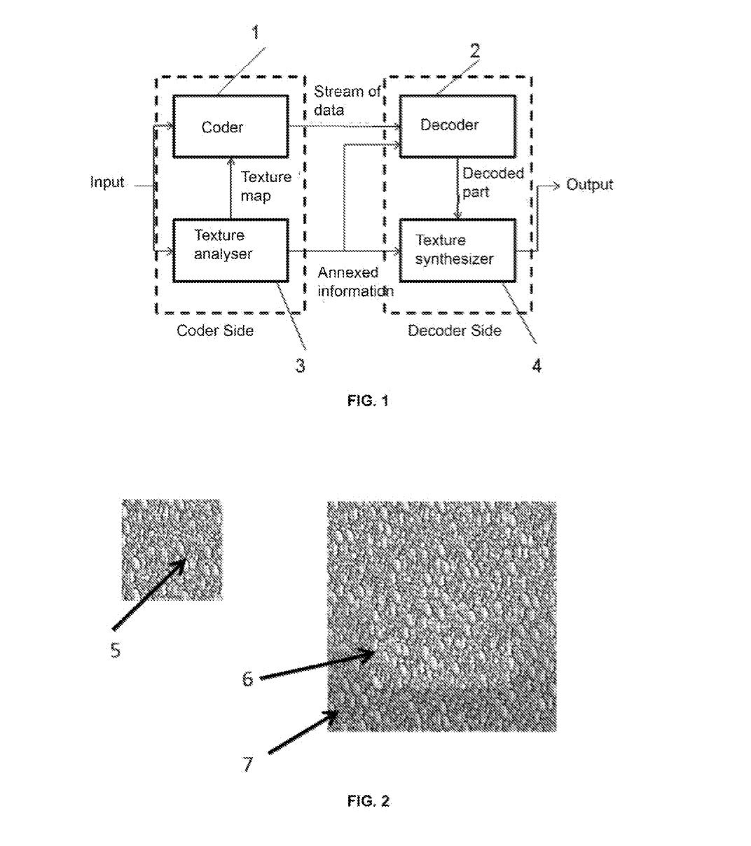

FIG. 1 shows a global schema of the coder/decoder carrying out the coding and decoding operations. The video signal to be coded is transmitted in parallel to the inputs of a coder 1 and a texture analyser 3. This analyser calculates a texture map that it transmits to the coder. It produces for example a segmentation of the picture in order to determine the regions that are supposed to be able to be synthesized at the decoder. These are then the regions that have properties of homogeneity and stability. Several techniques from the literature can be used here, notably the gradient calculations enabling, via thresholds, the contours of the objects or the structures to be isolated. The choice of areas to be preserved and the synthesis method to be used are a function of the nature of the texture being considered, for example the stability, the shape and size of the constituting patterns, this is in order to obtain better performances. The idea is not to code, or to code at a very low quality, a maximum of pixels of each of the regions and to let the decoder re-synthesize the texture that is missing or that is of low resolution.

The coder 1 thus receives a texture map giving for example the coordinates of blocks or regions called structure or structured blocks or regions, these are to be coded, the other blocks or regions called texture or textured blocks or regions are not to be coded or are to be coded at low resolution. The coder thus carries out the coding only of the structure blocks/regions and does not code or codes at low resolution the other blocks/regions, to supply a stream of coded data to the decoder 2.

The decoder 2 receives this stream of coded data and possibly annexed data transmitted by the texture analyser. The decoder carries out, in a standard manner the decoding of structure regions or blocks and of texture blocks roughly coded. These decoded parts are transmitted to the texture synthesizer 4 which will then take responsibility to recreate the missing texture blocks or to refine the texture blocks when they are roughly coded/decoded, to provide at output a stream of video data corresponding to the decoded pictures.

The information relative to the picture block such as its qualification, structure block or texture block, can be contained in an MPEG stream when such a standard is used by the coder 1. This information can also be part of the annexed data transmitted to the decoder and to the texture synthesizer.

The texture analyser 3 can also carry out, optionally, synthesis operations in order to determine, as indicated later, the size of comparison windows or other parameters of use to the texture synthesizer, information can then also be transmitted as annexed data. In fact, the picture used on the coder side is the source picture enabling good quality parameters to be obtained, the picture on the decoder side being a reconstructed picture, decoded. These annexed data thus enable the display quality and the processing rapidity of the texture synthesizer to be improved during decoding.

A synthesis algorithm that can be used by the texture synthesizer 4 is based on that described in the document by Li-Yi Wei and Marc Levoy, entitled “Fast texture synthesis using tree-structured vector quantization”, SIGGRAPH, Proceedings of the 27th annual conference on Computer graphics and interactive techniques, New York, N.Y., USA, 2000, pages 479-488, ACM Press/Addison-Wesley Publishing Co. The pixels are reconstructed one by one via the “comparison” of a set of pixels neighbouring the pixel to be reconstructed and called the comparison window, with those of the patch. When an area of the patch, of the same shape and sized as the window, minimizing the similarity criterion, for example the sum of differences squared, is found, the components of its candidate pixel are re-copied at the current position in the output texture. It thus involves a correlation of the comparison window with the pixels of the patch to determine, from this causal neighbouring area of the pixel to be reconstructed, the pixel of the patch corresponding to it.

However, this algorithm, selected due to its simplicity, is not adapted to the targeted use and only a few basic principles have been retained. The originality of the invention resides in the set of new mechanisms proposed in order to obtain a schema for texture synthesis adapted to compression that is efficient and relatively uncomplicated.

Patch/Ring

It is thus necessary to create a reference “patch”, from which will be “taken” the values of pixels in order to reconstruct the deleted or degraded surface. The first idea would be to cut out a block close to the area to be synthesized in the picture. However, this type of approach can lead to artefacts if the surface does not have good stable properties. A case of this type is presented in FIG. 2, in which a change in global luminance leads to visible frontiers between the synthesized area, referenced as 6 on the figure, and its borders, referenced as 7, decoded in a standard way, the block 5 being the reference patch. Note that, in this specific case, a taking into account of the global luminance can be applied.

To overcome these problems of multiple spatial consistencies, mean luminance, variation in the size of patterns, rotation, etc. it is proposed to define as reference patch the ring that is situated around the region to be synthesized, i.e. the pixels that were previously decoded/reconstructed. The reference patch is for example constituted of blocks belonging to the structured area constituted of the contour of the non-coded region. The width of this ring can be adapted to the size/shape of the comparison window to be considered. This width can thus be aligned with sizes multiples of standard block sizes (16×16, 8×8, 8×4, 4×4, etc.). The idea is that the ring contains the causal neighbouring area of the comparison window for the pixels to be synthesized bordering this reference patch. For example, a width of 16 pixels enables a match with the H.264 codec (1 macroblock) and enables the use of comparison windows, during the synthesis, of 11×11 or 13×13 pixels at maximum.

Scanning Order

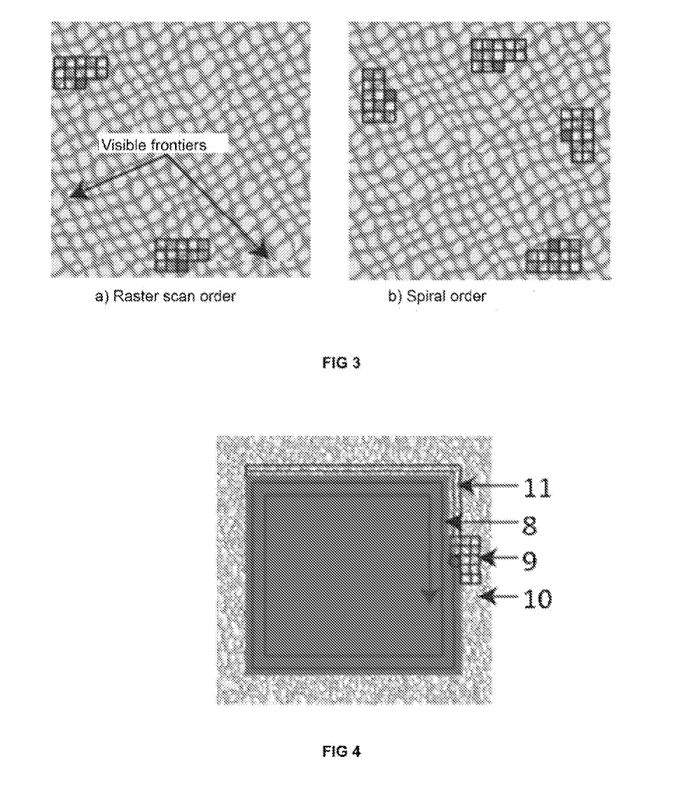

The algorithm presented in the document by Li-Yi Wei and Marc Levoy and based on a TV scanning or “raster scan” creates artefacts such as visible frontiers, an example of which is shown in FIG. 3a. In fact, the order of the raster scan is not suitable in a schema where the algorithm must rely on previously reconstructed borders. The causal neighbouring area doe not even contain any pixels of the border during the synthesis of the last line. Consequently, frontiers inevitably appear. One idea of the invention, to avoid this problem, consists in effecting a spiral scan, such as that presented in FIG. 4, that enables confidence pixels to be drawn upon, notably also via the rotation of the neighbouring area in order to remain causal. FIG. 3b shows the absence of faults, such as visible frontiers, obtained using this raster scan.

The (Neighbouring Area) Comparison Window

FIG. 4 represents a spiral scanning of the region. The comparison window, referenced 9 on the figure, is the window used to synthesize a pixel. The initial area 10, textured bright grey, corresponds to the decoded pixels, that is to say pixels of the structured region. The reference 8 indicates the spiral scanning order, the area 11 in dark grey becoming bright grey after synthesis, according to this scanning order, corresponds to synthesized pixels.

The comparison window is based on a grid or window of rectangular shape onto which a mask is applied. Preferentially, it is chosen in square form in order to avoid rotation at the corners, with a progressive mask. The comparison window 9 is thus, in reality, a grid or window of size 5×5 pixels, a mask covering the pixels of the part of the grid not shown. This mask corresponds for example to 2 columns on the left part plus 3 pixels in the central column for the position given on the figure, lower part plus 3 pixels in the central line for the pixels to be synthesized on the upper horizontal part.

As indicated above, the pixel used for the correlation is determined from the causal neighbouring area of the pixel to be synthesized. This causal neighbouring area, which is the comparison window, is correlated with the content of the reference patch, which is here ringed 10 to determine a position of the window providing the best correlation. The displacement of this window in the reference patch, for the correlation, is made for example horizontally and vertically with a step of one pixel or less than a pixel. Thus the pixel is used of the reference patch for which the position relative to the positioned correlation window is the same as that of the pixel to be created relative to this window. Naturally, after several scannings, the correlation window no longer contains pixels of the reference patch but synthesized pixels, the correlation continuing to be made in the reference patch.

Several window sizes, of different widths and lengths, can be used. If a size is better suited to the capture of a pattern, shape and orientation, it can be selected directly by the algorithm itself. To do this, a metric normalized by the surface is used, for example the Sum of Square Errors or SSE, for each of the window sizes considered and the one that provides the lowest metric value is retained.

A weighting of pixels of the window can also be used. The idea is particularly to assign a greater confidence to the pixels closest to the area to be synthesized. Gaussian or linear weightings can for example be used. The pixels previously synthesized on which the comparison window is based can also be weighted more weakly. The metric is then normalized by the surface and the different weights assigned to the pixels.

When the synthesis of adjacent pixels is based on the use of windows of sizes that are “too” different, results of lower quality have been experimentally observed in the areas. In order to overcome this problem, these transitions with too many differences should be limited and a smoothing favouring homogeneity of window sizes should be used. To do this, a solution consists in favouring, by differentially weighting, the window sizes mainly chosen in the adjacent pixels of that to be synthesized. Thus, the changes in size only operate for real pattern differences and the synthesis is improved.

This contribution has several effects, it can be used at the coder as well as at the decoder. Another solution consists in using several sizes during the coding to produce use statistics. The most used sizes will be transmitted and the decoder will then use the most representative sizes per region.

Blocks or Pixels Synthesis

In order to improve the performances of the synthesis algorithm and particularly in the presence of regular textures, a synthesis can be carried out not per pixel but per small block. Thus, a synthesis of a 2×2 or 4×4 block for example, enables an improvement of performances and a simplification of the synthesis tool. The correlation is carried out with a resolution at the pixel group level.

Equally, the block based predictors, that is to say the blocks obtained by correlation for the synthesis, can be placed in competition with those that are pixel based and this can be done for different window sizes.

Area to be Synthesized

According to an improvement of the invention, the method for synthesis uses the surface present under the pixels that will be synthesized. In this case, the comparison window contains not only pixels decoded or already synthesized but also pixels of the textured region not yet synthesized. It is thus possible to carry out a texture refinement that relies, if relevant, on the information already present on the region. This information is for example a version of low resolution, or over-quantized, or under-sampled or other. But this information can also be constituted using directional prediction methods such as those used for H.264/AVC INTRA prediction or a bi-linearly weighted version, or not, of neighbouring pixels, that is to say around the area to be synthesized. A luminance average of the area to be synthesized or an exploitation of DC coefficients only of blocks of the area to be synthesized can also be considered, the area being able to be the complete texture region or a part of the texture region.

There weightings can again be used in order to favour the reconstructed or the confidence pixels.

Acceleration/Complexity

It can be more efficient and pertinent to calculate the differences over a few pixels of the neighbouring area and not over the totality. This, a grid of pixels can be used, on which are carried out the calculations of distortions inside the comparison windows. More precisely, for the computation of the correlations, only one pixel out of 2 or 4 is taken into account in the correlation window also referred to as comparison window. For example, this grid can be constituted of one pixel in two in each direction. But it can also not be regular and be constituted of points of interest or representative points, for example in the salience areas. As an example, a saliency value is computed for each pixel of the correlation window, more precisely for the pixels of the causal area. Then the computation of the correlations is only based of those pixels of the causal area whose saliency value is higher than a given threshold.

Anchoring Point

The algorithm needs a confidence structure, it can in fact only detect changes in direction or frontiers during the synthesis. In order to make the construction of the region more robust, gradient calculations with finer thresholds enable anchor blocks to be detected that are then coded in a standard way. More precisely, a Sobel filter is applied on the image. Anchor blocks are then localized on the pixels having highest gradient values. These Anchor blocks are then encoded in a standard way therefore with highest quality. In fact, it may be pertinent to have detected a large region during the first segmentation and to want to then draw upon a few confidence blocks inside the region. These anchor blocks can be part of the reference patch. They can also be used as indicated above, as surface present under the pixels to be synthesized. In this last case, the grid used for the correlation is adapted to contain pixels of the anchor block when it is positioned during the spiral scanning, over all or part of this anchor block.

Deblocking

The standard techniques for filtering block effects are usefully applied to the texture resulting from the synthesis. The filters used are for example Wiener filters or adaptive interpolation filters.

The invention can also relate to the coding of the video source picture comprising these steps of segmentation of the picture into textured and structured regions. Thus, a synthesis of textured regions can be carried out at the coding, by applying the method described for the decoding, the spiral scanning from a reference patch of the structured area surrounding the textured area, in order to determine parameters for decoding better adapted to the content of pictures. Information relative to these parameters or the annexed information, such as the size of the correlation window, is transmitted to the decoder in order to facilitate for it the decoding task or to optimise this decoding during the synthesis of textured regions. An important advantage is that the reference patch, at the coder, is constituted of the video source picture and is thus not a reconstruction that may be tainted with coding/decoding errors. The parameters providing the best restitution quality by synthesis, by comparing then with this source picture, can thus be pre-selected and transmitted to the decoding system.

The invention is described in the preceding text as an example. It is understood that those skilled in the art are capable of producing variants of the invention without leaving the scope of the patent.

1. A method for decoding of a coded video picture according to first and second regions, a first region being coded with a given quality or resolution, a second region or part of it being coded at a lower quality, wherein a decoding complement of the second region is obtained by a texture synthesis step comprising correlating causal area neighbouring the pixel or group of pixels to be synthesized with similar areas in a reference texture patch, determining in the reference texture patch a best correlated area and determining the pixel or group of pixels that is positioned relative to this best correlated area as the pixel or group of pixels to be synthesized relative to its causal area, the reference texture patch being constituted of a part or of blocks of the first region forming a ring around the second region and the pixels of the second region being synthesized sequentially according to a spiral type scanning around the second region, and wherein, coding information relative to the second region is taken into account in using, for the determination of the best correlated area, in addition to the causal area, an area of the second region neighbouring the pixel or group of pixels to be synthesized.

2. The method according to claim 1, wherein an anchoring point being created in the second region by coding a block of the second region with a quality or resolution of that of a block of the first region, the coding information relative to this block is used for the determination of the best correlated area.

3. The method according to claim 1, wherein during the texture synthesis step correlations are carried out only on those pixels of the causal area having a saliency value higher than a threshold value.

4. The method according to claim 1, wherein the determination of the correlated area is carried out for several predefined sizes of the causal area.

5. The method according to claim 1, wherein the causal area is the visible part of a square shaped grid comprising the pixel or group of pixels to be synthesized, on which is applied an adaptive mask adapted to the spiral type scanning position, the mask hiding the pixels of the grid not yet reconstructed.

6. The method according to claim 1, wherein the determination of the correlated area is carried out with a resolution at the level of the pixel or of a group of pixels and in that the synthesis is made at the level of the pixel or at the level of the group of pixels, according to the best correlation obtained.

7. The method for coding a video source picture comprising a step of segmentation of the picture into first and second regions, a first region being coded with a given quality or resolution, a second region or part of it being coded with a lower quality, wherein it carries out a step of synthesis of the second region or region part to determine decoding parameters, this step comprising correlating a causal area neighbouring the pixel or group of pixels to be synthesized with similar areas in a reference texture determining in the reference texture patch a best correlated area and determining the pixel or group of pixels that is positioned relative to said best correlated area as the pixel or group of pixels to be synthesized relative to its causal area, the reference texture patch being constituted of an area or of blocks of the first region forming a ring around the second region and the pixels of the texture region being synthesized sequentially according to a spiral type scanning around the second region, the choice of decoding parameters being determined by a comparison between the synthesized second region and the second region of the video source picture, and wherein the coding information relative to the second region is taken into account in using, for the determination of the best correlated area, in addition to the causal area, an area of the second region neighbouring the pixel or group of pixels to be synthesized.

8. The method according to claim 7, wherein the decoding parameters are the size and dimensions of the causal area to be taken into account for the correlation, during the decoding.

9. A coder for coding a video source picture comprising a module configured to segment the picture into first and second regions, a first region being coded with a given quality or resolution, a second region or part of it being coded with a lower quality, wherein the coder comprises a texture analyzer carrying out synthesis of the second region or region part to determine decoding parameters, the texture analyzer comprising a module to correlate a causal area neighbouring the pixel or group of pixels to be synthesized with similar areas in a reference texture patch, a module to determine in the reference texture patch a best correlated area and a module to determine the pixel or group of pixels that is positioned relative to said best correlated area as the pixel or group of pixels to be synthesized relative to its causal area, the reference texture patch being constituted of an area or of blocks of the first region forming a ring around the second region and the pixels of the texture region being synthesized sequentially according to a spiral type scanning around the second region, the choice of decoding parameters being determined by a comparison between the synthesized second region and the second region of the video source picture, and wherein the coding information relative to the second region is taken into account in using, for the determination of the best correlated area, in addition to the causal area, an area of the second region neighbouring the pixel or group of pixels to be synthesized.

10. The coder according to claim 9, wherein the decoding parameters are the size and dimensions of the causal area to be taken into account for the correlation, during the decoding.

11. A decoder for decoding a coded video picture according to first and second regions, a first region being coded with a given quality or resolution, a second region or part of it being coded at a lower quality, wherein the decoder comprises a texture synthetizer for obtaining a decoding complement of the second region, the texture synthetizer comprising a module configured to correlate a causal area neighbouring the pixel or group of pixels to be synthesized with similar areas in a reference texture patch, a module configured to determine in the reference texture patch a best correlated area and a module configured to determine the pixel or group of pixels that is positioned relative to this best correlated area as the pixel or group of pixels to be synthesized relative to its causal area, the reference texture patch being constituted of a part or of blocks of the first region forming a ring around the second region and the pixels of the second region being synthesized sequentially according to a spiral type scanning around the second region, and wherein coding information relative to the second region is taken into account in using, for the determination of the best correlated area, in addition to the causal area, an area of the second region neighbouring the pixel or group of pixels to be synthesized.

12. The decoder according to claim 10, wherein an anchoring point being created in the second region by coding a block of the second region with a quality or resolution of that of a block of the first region, the coding information relative to this block is used for the determination of the best correlated area.

13. The decoder according to claim 10, wherein, in the texture synthetizer, correlations are carried out only on those pixels of the causal area having a saliency value higher than a threshold value.

14. The decoder according to claim 10, wherein, in the texture synthetizer, the determination of the correlated area is carried out for several predefined sizes of the causal area.

15. The decoder according to claim 10, wherein the causal area is the visible part of a square shaped grid comprising the pixel or group of pixels to be synthesized, on which is applied an adaptive mask adapted to the spiral type scanning position, the mask hiding the pixels of the grid not yet reconstructed.

16. The device according to claim 10, wherein the determination of the correlated area is carried out with a resolution at the level of the pixel or of a group of pixels and in that the synthesis is made at the level of the pixel or at the level of the group of pixels, according to the best correlation obtained.
